(19) United States
(12) Patent Application Publication
(10) Pub. No.: US 2015/0170093 A1
(43) Pub. Date: Jun. 18, 2015

(54) Break Management in Business Center or the Like

(71) Applicant: ASD Inc., Media, PA (US)

(72) Inventors: Martin CZACHOR, JR., Newtown Square, PA (US); Kevin CZACHOR, West Chester, PA (US); Norman FRANKE, Garnet Valley, PA (US); Gary FOSTER, Media, PA (US)

(73) Assignee: ASD INC., Media, PA (US)

(21) Appl. No.: 14/109,177

(22) Filed: Dec. 17, 2013

(51) Int. Cl. G06Q 10/06

(52) U.S. Cl. CPC G06Q 10/063116

(57) ABSTRACT

Each agent in a work setting is able to take work breaks as needed to devote personal time to attend to personal matters. An agent module is associated with a computing device of each agent and a central module is central to all of the agents. The agent module receives a request from the agent for a work break and forwards the request to the central module for processing thereat. The central module examines the request according to a set of rules to determine whether and/or when the request for the work break from the agent is to be approved, and grants the request based on the set of rules. Thereafter, the central module notifies the agent by way of the agent module that the request has been granted. Thus, the agent may take the requested work break.

### FIELD

The present disclosure relates to a work setting such as business center or the like as operated by a business organization or the like, where the work setting business center includes a plurality of agents or the like working therein, the agents for engaging in servicing clients of the organization, perhaps remotely located with respect thereto, perhaps via communicative links established therebetween. More particularly, the present disclosure relates to such a business center or the like where a break management system is provided to allow the agents to take work breaks in an efficient manner and without leaving the business center under-staffed and the clients under-served.

### BACKGROUND

As may be known, a business center or the like may be established by or on behalf of a business organization in order that the business organization may effectuate contact with clients thereof in order to service the clients in the course of operating the business organization. The business center may be established primarily to receive incoming calls from the clients regarding the business organization and the goods and/or services offered thereby, and/or to generate outgoing calls to the clients regarding same, and/or to see the clients in person at such business center. For example, the business center may be a call center, in which case the business center may handle incoming and/or outgoing calls such as telephone calls, although other types of calls and modes of contact with clients may also be employed. Likewise, the business center may be a banking center, in which case the business center may handle in-person banking transactions with banking clients, although other types of transactions with clients may also be employed.

In the business center, a plurality of service agents may be arranged to handle transactions with clients, where each service agent may be trained by or on behalf of the business center to handle transactions in a prescribed manner or may be expected to handle each transaction on an ad hoc basis. Typically, although by no means necessarily, each agent is situated at a work station with a computing device, work-related materials and supplies, call communication equipment, and the like. As should be understood, the computing device in particular may be a computer or terminal or the like that allows the agent access to data and other information relevant to the client, and that also may provide the agent with a script or the like that the agent may refer to in the course of conducting a transaction with the client. The computing device may include software or the like specifically tailored to the operation of the business center and the activities of the agent at the computing device, and it may in fact be the case that that the computing device and software may control the call communication equipment as employed by the agent at such computing device.

Ordinarily, it can be expected that the business center has a sufficient number of agents therein to conduct transactions with clients in a timely manner. Thus, it should not be the case that a client has to wait an inordinate amount of time before an agent becomes available to service the client. However, circumstances may at times require that a client wait an amount of time less than the aforementioned inordinate amount of time, but still longer than may be considered acceptable. For example, if the client arrives at an especially busy time of the day, such as right before lunchtime or right before the end of regular business hours, it might happen that the client would be expected to wait more than if such client arrived at a less busy time. Nevertheless, and again, the client should not be made to wait longer than may be considered acceptable.

Correspondingly, it can be expected that each agent at the business center periodically may require some personal time in order to take care of matters not related to the business center, during which the agent may withdraw from the work station thereof and is not available to conduct transactions with the clients. Reasons for the need for such personal time are many and varied, but generally can be expected to be in the nature of the agent checking in with a family member, using the bathroom, relieving built-up stress, obtaining a refreshment, and/or otherwise attending to the personal business that arises for each person from time to time. While the need for such personal time is to be expected and even anticipated, such personal time should not if at all possible unduly detract from the ability of the business center to service the clients thereof. In particular, such personal time should not be so often and/or so excessive, both for each agent individually and all of the agents collectively, so as to cause agents to be not available to service clients in a timely manner and require clients to wait longer than may be considered acceptable.

Accordingly, a need exists for a system and method for managing the use of personal time by agents at a business center. Specifically, a need exists for such a system and method that ordinarily allows each agent at the business center to take personal time if such personal time is not expected to unduly detract from the ability of the business center to service the clients thereof. In particular, a need exists for such a system and method where an agent is ordinarily granted personal time if predefined conditions within the business center are satisfied, the predefined conditions corresponding to a set of rules for when personal time may be granted to an agent. Accordingly, the agents at the business center can take personal time as needed while the business center can service the clients thereof in a timely manner.

### SUMMARY

The aforementioned needs are satisfied by a system and method for managing work breaks of agents in a work setting. Each agent in the work setting works at a computing device, and each agent is able to take work breaks as needed to devote personal time to attend to personal matters. An agent module is associated with the computing device of each agent and a central module is central to all of the agents

The agent module receives a request from the agent for a work break and forwards the request to the central module for processing thereat. The central module receives the request from the agent module, examines the request according to a set of rules to determine whether and/or when the request for the work break from the agent is to be approved, and grants the request based on the set of rules. Thereafter, the central module notifies the agent module that the request has been granted and the agent module likewise notifies the agent that the request has been granted. Thus, the agent may take the requested work break.

### BRIEF DESCRIPTION OF THE DRAWINGS

The foregoing summary as well as the following detailed description of various embodiments of the present innovation will be better understood when read in conjunction with the appended drawings. For the purpose of illustrating the various embodiments of the innovation, there are shown in the drawings embodiments that are presently preferred. As should be understood, however, the innovation is not limited to the precise arrangements and instrumentalities shown. In the drawings:

FIG. 1 is a block diagram of an example of a computing environment within which various embodiments of the present innovation may be implemented;

FIG. 2 is a block diagram showing a business center wherein a plurality of agents at work stations converse with clients in various embodiments of the present innovation;

FIG. 3 is a block diagram showing a work station of FIG. 2 as employed by an agent of the business center, where the work station includes at least a portion of a break management system in various embodiments of the present innovation;

FIG. 4 is a flow diagram showing actions performed by the break management system of FIG. 3 in accordance with various embodiments of the present innovation.

### DETAILED DESCRIPTION OF PREFERRED EMBODIMENTS

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the plural of that term is also contemplated unless circumstances clearly dictate otherwise. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by the relevant public. Although any methods and materials similar or equivalent to those described herein can be used in the practice or testing of the present innovation, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

### Example Computing Environment

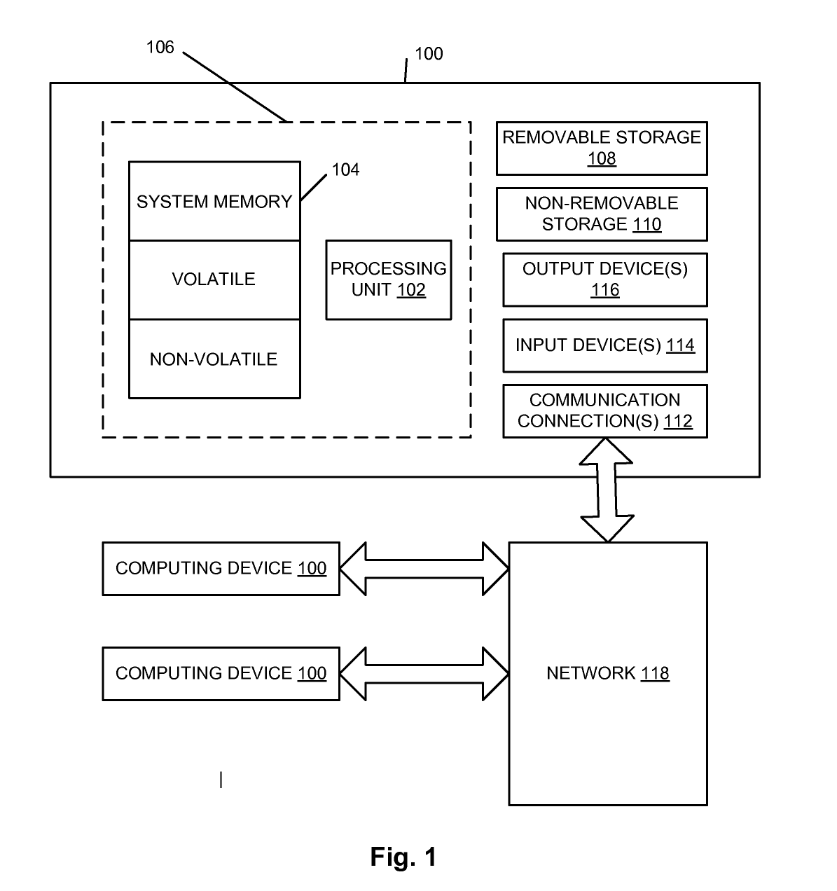

FIG. 1 is set forth herein as an exemplary computing environment in which various embodiments of the present innovation may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (PCs), server computers, handheld or laptop devices including smart phones and computing tablets, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features and functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes or is provided with a variety of computer-readable hardware media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other computer-readable hardware medium which can be used to store the desired information and which can accessed by computing device 100. Any such computer storage media may be part of computing device 100.

Computing device 100 may also contain communications connection(s) 112 that allow the device to communicate with other devices 100. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection (including VoIP), and wireless media such as acoustic, radio frequency (RF), infrared, WiFi, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like. Likewise, the network 118 may be such an external network.

Particularly in the case where the network 118 is an external network, such network 118 may be a digitally based network (including VoIP) for exchanging computer data among the devices 100, may be an audio and/or video network for exchanging audio and/or video data among the devices 100, or the like. Thus, it may be that the network 118 may be the Internet, a public switched telephone network for landline telephone communications, a mobile switching center for wireless telephone communications, a paging network for distributing paging information, a private multimedia network for establishing videoconferencing, or the like. Thus, it should be appreciated that one or more of the computing devices 100 that are shown to the left of the network 118 in FIG. 1 may be a mobile telephone, a landline telephone, a pager, a mobile electronic mail device, a desktop electronic mail device, a mobile electronic texting device, a desktop electronic texting device, or a combination thereof, or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, so-called thumb drives and/or flash drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

### Business Center

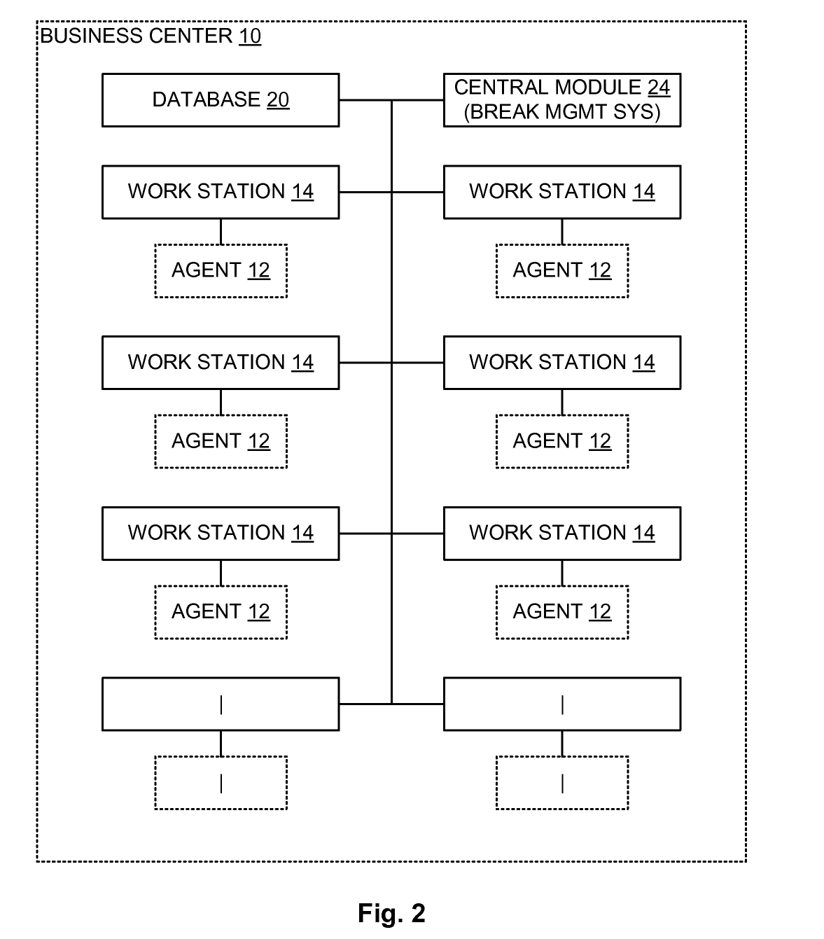

Turning now to FIG. 2, it is seen that a business center 10 is provided by or on behalf of a business organization in order that the business organization may effectuate contact with clients thereof in order to service the clients in the course of operating the business organization. The business center 10 may be a call center that receives incoming calls from the clients and/or generate outgoing calls to the clients regarding same. Typically, the incoming and/or outgoing calls are telephone calls effectuated via a public switched telephone network, although other types of calls may also be employed without departing from the spirit and scope of the present innovation. For example, the calls alternately may be video or audiovisual calls and/or effectuated via a data and/or packet-based network. Also, the business center 10 may be an in-person location that conducts face-to-face transactions with clients that have traveled to the business center. For example, the business center 10 may be a bank or securities firm where clients travel to obtain a loan or open an account, or may be a job center where clients travel to apply for a job, among other things.

In the business center 10, a plurality of call-handling agents, client-representative agents, service agents, or other individuals 12 are employed to service the needs of the clients of the business center 10, perhaps by greeting and helping clients in-person, handling calls from clients, making call to clients, and the like. Notably, each service agent 12 is trained by or on behalf of the business center 10 to service the needs of the clients in a prescribed manner or may be expected to do so on an ad hoc basis, which is to say that the present innovation contemplates agents 12 employed specifically to service clients and also agents 12 that service clients in the course of their employment among other things. Typically, although by no means necessarily, each agent 12 is situated at a work station 14.

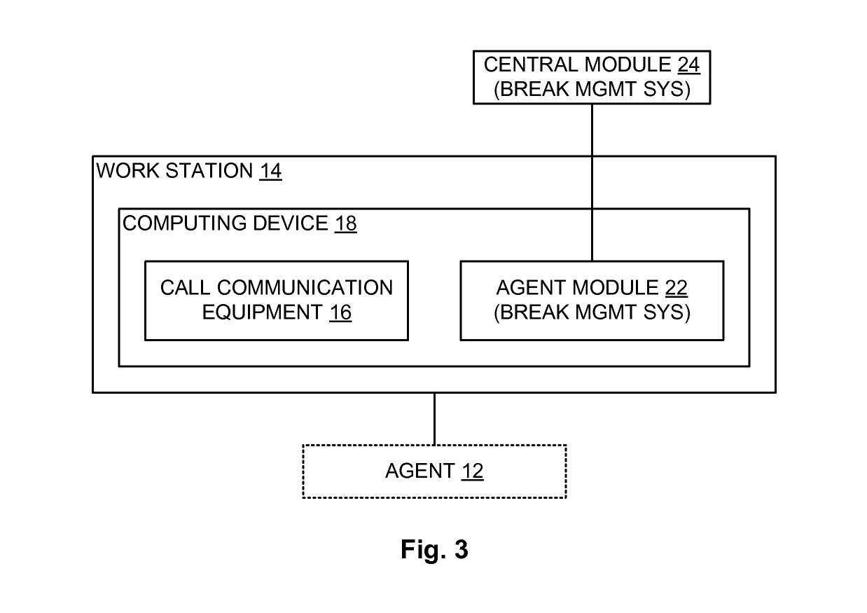

As is to be expected, each work station 14 includes work-related materials and supplies as may be necessary and/or advisable. For example, if the business center 10 encompassed an automobile dealership, it may be that each work station 14 includes brochures and specifications for automobiles sold by the dealership, as well as forms required during the normal course of buying and/or selling automobiles, among other things. Turning now to FIG. 3, it is seen that each work station 14 also may be provided with call communication equipment 16 if need be and a computing device 18. The call communication equipment 16 may include a headset or handset or the like whereby the agent 12 can communicate at least aurally (i.e., by voice) with a client by way of the call communication equipment 16. Thus, the call communication equipment 16 for example may be a typical telephone, or may be a headset with a transmitting microphone and a receiving earpiece. In the case of a headset, the headset may be communicatively coupled with a separate telephone or the like or may be communicatively coupled directly to the computing device 18, in which case the computing device 18 includes at least a portion of the call communication equipment 14 (shown in FIG. 3) and appropriate communications couplings and functionality for effectuating necessary communications between the agent 12 and the client.

Note that at least a portion of the call communication equipment 16 may be embodied by way of appropriate hardware of the computing device 18 and at least a portion of the call communication equipment 16 may be embodied by way of appropriate software running on the hardware of the computing device 18. Such call communication equipment 16 is known or should be apparent to the relevant public and therefore need not be set forth herein in any detail other than that which is set forth. Accordingly, such call communication equipment 16 may be any appropriate equipment without departing from the spirit and scope of the present innovation as long as the equipment 16 provides the functionality necessary for the innovation.

The computing device 18 may be a computer or terminal or the like that allows the agent 12 to access and store data and other information relevant to the client. Typically, such data is accessed from and/or stored to a centralized database 20 or the like (FIG. 2) in which case each computing device 18 is appropriately communicatively coupled to such database 20 by way of an appropriate network or the like. Such database 20 and network may be any appropriate database and network without departing from the spirit and scope of the present innovation, although presumptively the network and database 20 are tailored toward the functionality performed by the agents 12 and business center 10.

In at least some circumstances each agent 12 in the business center 10 operates according to a script or the like that the agent 12 may refer to in the course of communicating with the client. The script may be any appropriate script, although presumptively the script is customized to the purpose of the communication between the agent 12 and the client. For example, if the business center 10 answers telephone calls on behalf of funeral directors, the script may effectuate conversations regarding funeral services. Likewise, if the business center 10 sells industrial machinery to warehouse managers, the script may effectuate conversations regarding details of the machinery and available options for the machinery. Typically, although by no means necessarily, the script not only guides the agent 12 in the conversation but also retrieves relevant data pertaining to the conversation from the database 20 and also stores data collected by the agent 12 in the course of the conversation with the client in the database 20. As should be evident, the script if employed may be most any appropriate script.

The computing device 18 may include software or the like specifically tailored to the operation of the business center 10 and/or the activities of the agent 12 at the computing device 18, and it may in fact be the case that that the computing device 18 and software may control the call communication equipment 16 as employed by the agent 12 at such computing device 18, run the aforementioned script, and otherwise perform the functionality required for the activities performed by the agent 12 at the business center 10. Such software may include most any appropriate software and provide most any functionality as may be desired. The software may be commercially available call-handling and data-manipulating software, may be customized call-handling and data-manipulating software, or may be a combination thereof.

As was set forth above, the business center 10 should be expected to have a sufficient number of agents 12 therein to conduct transactions with clients in a timely manner. Thus, it should not be the case that a client has to wait an inordinate amount of time before an agent becomes available to service the client. Such an inordinate amount of time may be subjectively determined, but in any case should not be longer than would cause more than a minimal number of clients to give up and go away from the business center 10, especially if clients that give up may be expected to seek similar service from a rival business center.

That said, circumstances may at times require that a client wait an amount of time less than the aforementioned inordinate amount of time, but still longer than may be considered acceptable. In particular, in the normal ebb and flow of business, there are times when the business center 10 is expected to be more busy and yet such business center does not have additional agents 12 immediately available to service the corresponding additional demand. For example, if the client arrives just before lunchtime or before the end of regular business hours, it might happen that the client would be expected to wait more than if such client arrived at a less busy time. Although it is hoped that the client would appreciate that the business center 10 is especially busy and a wait for service from an agent 12 at the business center 10 may be required, the client cannot be expected to have infinite patience and thus should not be made to wait longer than may be considered acceptable.

### Break for Personal Time

As was also set forth above, even with the ebb and flow of business, it can be expected that each agent 12 at the business center 10 periodically may require a break for some personal time in order to take care of matters not related to the business center 10, during which the agent may withdraw from the work station 14 thereof and is not available to conduct transactions with the clients. At a minimum, common sense should be consulted to determine when an agent 12 should be allowed to take a break for personal time, but it is expected that the business center 10 likely has specific rules detailing when, why, and how each agent 12 may take personal time.

For example, an agent 12 may take personal time only when demand for services of the business center 10 is relatively low such that the agent 12 will not be especially missed during the taking of personal time thereby. Thus, it may be that if such demand is usually high between 8 AM and 10 AM the first business day after weekend days and holidays, then the agent 12 may not ordinarily take personal time during such a time period. Similarly, if more than a set number of agents 12 are currently taking personal time such that less than a full complement of agents 12 are available to service clients, then the agent 12 may not ordinarily take personal time until such full complement of agents 12 becomes available to service clients. Likewise, if the agent 12 has already taken more than a set amount of personal time, either measured by incident or by time, it may be that the agent 12 may not ordinarily take any more personal time. In any instance, and as was set forth above, the need for such personal time is to be expected and even anticipated but should not if at all possible unduly detract from the ability of the business center 12 to service the clients thereof. Accordingly, breaks for personal time should be granted to agents 12 bearing in mind that the agents 12 need to be available to service clients of the business center 10 in a timely manner and without making the clients wait longer than may be considered acceptable.

Reasons for why an agent 12 may take personal time are many and varied, but generally can be expected to be to allow the agent 12 to attend to non-business related matters that arise from time to time, where it is not unreasonable to expect that the agent 12 may need to attend to such matters during business time. For example, it may be that the agent needs to stretch one's legs, contact a family member, use the bathroom, relieve built-up stress, obtain medicine, obtain a refreshment, and/or otherwise attend to personal business that arises for each person from time to time. Note that a business center 10 may allow agents thereof to take personal time for no specific reason, or may allow breaks for personal time only if specific reasons apply, among other things.

As should be appreciated, the rules employed by the business center 10 regarding agents 12 taking breaks for personal time may be most any rules without departing from the spirit and scope of the present innovation. Moreover, although the rules for personal time hopefully have some rational basis and are objectively applicable, such rational basis and objective applicability are by no means a requirement of the present innovation. Accordingly, such rules need not be set forth herein in any detail other than that which is provided.

An agent 12 at a business center 10 might ordinarily take a break for personal time only after communicating with a supervisor or other overseeing person regarding the need for the personal time. Hopefully, a request for the break for the personal time is granted to the agent 12 if available according to any specific rules of the business center 10. Note, though, that having the break granted by a supervisor or other overseeing person introduces an element of subjectivity to such granting, which can be undesirable. For example, it may be that the supervisor grants more breaks and more liberally grants breaks to one type of agents 12 over another, according to an unacceptable bias. Likewise, it may be that the supervisor withholds breaks from a particular agent 12 based on a personal dislike. In either case as well as others, the favoritism in granting breaks or the lack thereof can cause personnel problems in the business center 10, including disharmony and an unsatisfactory work environment, and can even be grounds for charges of unfairness or worse.

Note too, that by requiring an agent 12 to communicate with a supervisor to request a break, the agent 12 is taking significant time away from servicing clients not only for the break but for the request too. Moreover, in the event that the supervisor is also expected to be servicing clients, the request for the break requires taking significant time away from the business center being able to service two clients.

### Break Management System

In various embodiments of the present innovation, then, a break management system is provided to manage the taking of breaks for personal time by agents 12 or the like in a business center 10 or the like. The break management system 22 is automated and operates according to predetermined rules of the business center 10 and does not require that an agent 12 obtain permission for a break from a supervisor or the like. Thus, the granting of breaks may be administered more efficiently, more objectively, and without bias so as to promote harmony and fairness in the work environment of the business center 10. Also, the granting of breaks does not as significantly detract from the ability of the business center 10 being able to service clients in the course of the breaks being requested.

Generally, the break management system includes an agent module 22 (FIG. 3) at the work station 14 and/or computing device 18 of each agent 12 and a central module 24 (FIG. 2 and FIG. 3) central to all of the agents 12 of the business center 10. As may be appreciated, the central module 24 may be sited at any appropriate location, such as for example at or in conjunction with the database 20, or at or in conjunction with a computing device 18/work station 14 or the like of a supervisor or the like, or elsewhere. Presumptively, each agent module 22 and the central module are primarily implemented as software on hardware, but may also be implemented in any alternate fashion as may be deemed necessary and/or advisable.

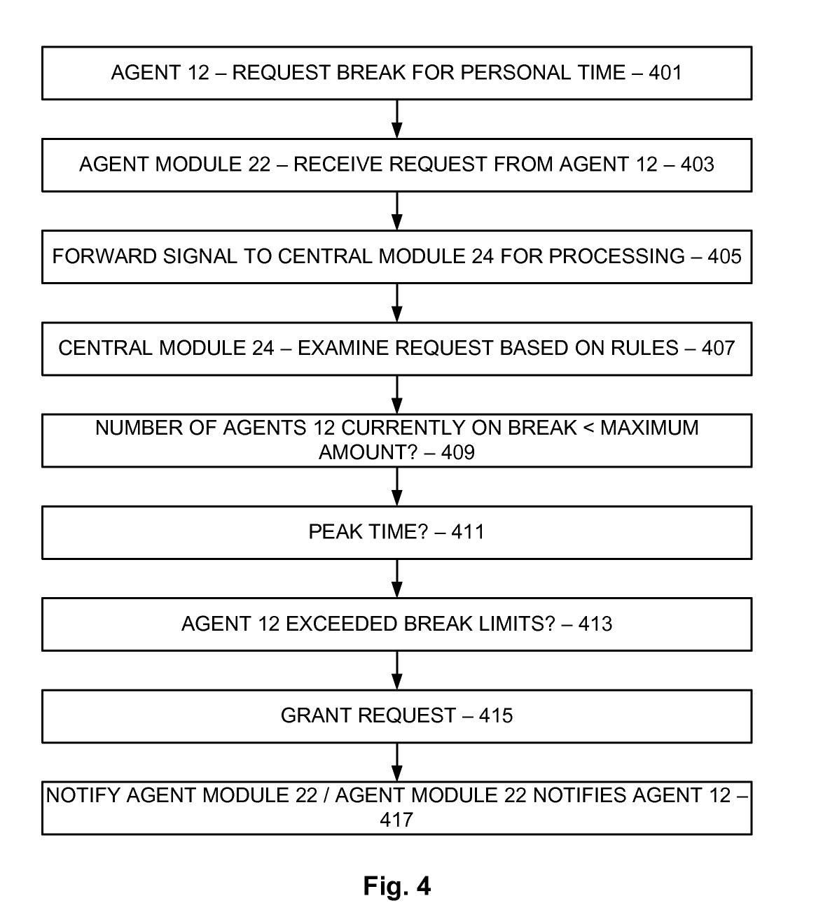

With reference to FIG. 4 now, it is seen that the break management system including the agent module 22 at each work station 14 and the central module 24 is operated in the following fashion. Initially, an agent 12 working at the business center 10 decides for whatever reason that a break for personal time is to be requested for such agent 12 (401). Accordingly, the agent 12 signals to the agent module 22 of the computing device 18/work station 14 of such agent 12 that such a break is to be requested, and the agent module 22 indeed receives such request (403). Signaling the request to the agent module 22 and receiving same may be performed in any appropriate manner without departing from the spirit and scope of the present innovation. For example, it may be that as part of the computing device 18/work station 14 of the agent 12, the agent module 22 displays on a display or the like of the computing device 14 a “Request Break” virtual button or the like which may be selected by the agent 12 by way of a pointing device moving a cursor, a touch-sensor of the display receiving a touch from the agent 12, or the like. If so, it may be that upon receiving the request as at 403, the agent module 22 posts a message or the like to the agent 12 regarding same, such as for example by changing the “Request Break” virtual button to read “Request Received”, “Request in Process”, or the like.

The request as received by the agent module 22 may be catalogued, logged, or otherwise recorded as may be deemed necessary and/or advisable, and is forwarded to the central module 24 for processing (405). In particular, as received at the central module 24, the request is examined according to a set of rules to determine whether and/or when the request for the break for the agent 12 is to be approved (407). In various embodiments of the present innovation, the central module 24 upon receiving the request places same in a request queue with other requests from other agents 12, and handles each request serially as retrieved from the request queue, although other devices for handling requests from multiple agents 12 may also be employed without departing from the spirit and scope of the present innovation. Note that by employing a request queue, the central module 24 can handle and grant multiple requests from multiple agents 12 in the order requested, which should be recognized as generally fair.

If indeed a request queue is employed by the central module 24, it may be that such central module 24 retrieves the next request from the request queue only if a number of agents 12 currently on break for personal time has not reached a preset maximum amount (409). Thus, the central module 24 prevents too many agents 12 from being on break at any one time. Note here that the preset maximum amount of agents 12 on break at any one time may be any amount and may vary based on conditions at the business center 10 and/or other conditions without departing from the spirit and scope of the present innovation. For example, it may be that the maximum amount of agents 12 on break at any one time is limited to a fixed number or a calculated variable, such as a percentage of all agents 12 on duty at the business center 10, a percentage of all agents 12 on duty at the business center 10 but no less than a fixed number, a variable number that varies according to time of day and anticipated demand, a variable number that varies according to day of week and/or month and anticipated demand, and/or the like.

Also if indeed a request queue is employed by the central module 24, it may be that such central module 24 does not retrieve the next request from the request queue if the request is received during a preset peak time (411). Thus, the central module 24 ensures that all agents 12 are ordinarily off their breaks for personal time during periods of peak activity at the business center 10. Note here that the preset peak times may be any peak times and may vary based on conditions at the business center 10 and/or other conditions without departing from the spirit and scope of the present innovation. For example, it may be that the business center 10 is especially busy from 4 to 5 pm every day, which may be defined as a first peak time for the central module 24, and that the business center 10 is especially busy from 8 to 10 am the first business day after a weekend day or a holiday, which may be defined as a second peak time, and that the business center 10 is especially busy from 8 am to 12 noon the last business day of each month, which may be defined as a third peak time.

As should now be appreciated, other rules of the business center 10 may establish other rationales for which the central module 24 would not be able to retrieve the next request from the request queue. Such rules can be any rules without departing from the spirit and scope of the present innovation, presuming that such rules are amenable to be programmed into a logical form upon which the central module 24 can operate.

Presuming now that the central module 24 is indeed capable of requesting the next request from the request queue and indeed has so retrieved same, it may be that the central module 24 grants the (retrieved) request (415) forthwith and without any further ado, or it may be that the (retrieved) request is granted only if further rules are satisfied. Presumptively, the further rules would be specific to the requesting agent 12, although the further rules may be characterized in an alternate manner as may be necessary and/or appropriate.

In the context of such further rules that are specific to the requesting agent 12, it may be that central module 24 tracks for each agent 12 the breaks for personal time thereof, perhaps including the number and/or temporal amounts (elapsed time) thereof, and that the central module 24 grants each request for a break from the agent 12 only if such agent 12 has not exceeded a preset number of breaks, a preset cumulative temporal amount of breaks, and/or the like (413). Note here that the preset number of breaks and/or preset cumulative temporal amount of breaks may be any numbers and/or amounts without departing from the spirit and scope of the present innovation. For example, it may be that each agent 12 is allotted two breaks per 4 hour shift and five breaks per 8 hour shift, 60 minutes of breaks per month, three breaks and no more than 45 minutes cumulatively per 8 hour shift, and/or the like.

Note too that if the central module 24 tracks for each agent 12 the breaks for personal time thereof, it may be that the business center 10 can incentivize each agent 12 for minimizing breaks and/or penalize each agent 12 for excessive breaks. Such incentives and/or penalties may be most any incentives/penalties without departing from the present innovation. For example, the business center may pay a bonus to each agent 12 for each minute of break not used by the agent 12 from a preset number of break minutes for the agent 12 per month, or may dock each agent 12 for each break used by the agent 12 over a preset number of breaks for the agent 12 per week, among other things.

Upon granting each break as at 415, the central module 24 notifies the corresponding agent module 22 of same and the agent module 22 in turn notifies the corresponding requesting agent 12 (417). The notification from the agent module to the requesting agent 12 may be any appropriate notification without departing from the spirit and scope of the present innovation. For example, it may be that the agent module 22 flashes an appropriate message on a display or the like of the computing device 14 of the agent 12, and/or that the aforementioned “Request Break” virtual button or the like is changed to read “On Break”, perhaps with a timer showing an elapsed time of the break, and/or that the entire display is changed to an “On Break” message, perhaps with an accompanied locking of the computing device 14 and the timer showing an elapsed time of the break, or the like. Thus, the requesting agent 12 is now on break and may withdraw from his or her work station 14 and/or computing device 18 to attend to whatever personal matter necessitated the corresponding request for the break.

If indeed the central module 24 tracks for each agent 12 the breaks for personal time thereof, and particularly if the central module 24 tracks for each agent 12 the temporal amount/elapsed time of the breaks, it may be that upon granting each break as at 415 the central module 24 moves the corresponding request from the request queue to an on-break list or the like in which is noted an identification of the agent 12 on break and the time that the break began. Accordingly, when the agent 12 returns and ends the break thereof and the central module 24 is notified of same, such central module 24 may then refer to the on-break list for the time that the break began, calculate the temporal amount/elapsed time of the break based thereon, and perform whatever accounting may be necessary. Such accounting may be any appropriate accounting without departing from the spirit and scope of the present innovation, and should be apparent to the relevant public and therefore need not be set forth herein in any detail.

As may now be appreciated, the returning agent 12 may end the break in the following manner. Presumptively, the returning agent 12 has arrived back at the computing device 18 thereof and the computing device 18 is in some sort of on-break state, perhaps with the aforementioned “On Break” message, locking of the computing device 14, and timer, or the like. Accordingly, the returning agent 12 signals to the agent module 22 of the computing device 18/work station 14 of such agent 12 that such a break is ending, and the agent module 22 indeed receives such break-ended signal. Signaling the end of the break to the agent module 22 and receiving same may be performed in any appropriate manner without departing from the spirit and scope of the present innovation. For example, the break-ended signal may be achieved by unlocking the computing device. Likewise, if the agent module 22 displays the aforementioned “On Break” virtual button, the returning agent 12 may select same to effectuate the break-ended signal. If so, it may be that upon receiving the break-ended signal, the agent module 22 changes the “On Break” virtual button back to read “Request Break” or the like in anticipation of a future break for the agent 12.

The break-ended signal as received by the agent module 22 may be catalogued, logged, or otherwise recorded as may be deemed necessary and/or advisable, and is forwarded to the central module 24 for processing. In particular, as received at the central module 24, the break-ended signal causes such central module 24 to close out the corresponding break of the agent 12. As should be understood, closing out the break may be performed in any appropriate manner without departing from the spirit and scope of the present innovation. For example, the closing out of the break may involve the aforementioned accounting for the break, as well as determining whether another request can be retrieved from the request queue, among other things.

As may be universally appreciated, sometimes a break for personal time is needed immediately and is not susceptible to a wait for permission from an external source, be it a supervisor or the central module 24 of the break management system. Decorum and civility prevent further explanation in excessive detail, but suffice it to say that at times an agent 12 needs to withdraw from his or her work station 14/computing device 18 urgently and not in an ordinary manner, perhaps even as an emergency, and without regard for whether the business center 12 can accommodate the imminent absence of the agent 12 based on demand, time of day, availability of other agents 12, or otherwise. In such an instance, and as an act of humanity, it may be that the agent module 22 displays on a display or the like of the computing device 14 a “BREAK NOW” virtual button or the like which may be selected by the ‘urgent’ agent 12. If so, it may be that upon receiving a signal that the “BREAK NOW” button has been actuated by the corresponding agent 12, the agent module 22 immediately notifies the central module 24 of same as at 405 without further ado, that the central module 24 immediately processes the corresponding agent 12 as being on break as at 415 without further ado, and notifies the agent module 22 regarding same as at 417 without further ado. Thus, both the agent module 22 and central module 24 treat the urgent agent 12 as being on break in a manner substantially as before. As may be appreciated, minor differences may be advisable, including that the central module 24 may notify a supervisor regarding the ‘urgent’ agent 12 and the break thereof, and/or may perform special accounting regarding the ‘urgent’ agent 12 and the break thereof.

In various embodiments of the present innovation, it may be considered useful to notify agents 12 regarding the status of the availability of breaks. Such status may be any appropriate status, such as for example that breaks are available, that breaks are not available, that a set number of breaks are available, that a set number of breaks are being taken, that specific individuals are on break, that specific individuals are awaiting a break, and the like. In any such instance, it may be that the central module 24 of the break management system periodically communicates to all of the agent modules 22 relevant information concerning such status, and each agent module 22 then communicates such status to the corresponding agent 12, perhaps by way of a message or control on a display or the like of the corresponding computing device 14. Thus, with such status, agents 12 may more intelligently choose whether to request breaks. For example, an agent 12 upon seeing that a relatively large number of other agents are waiting for breaks may decide not to bother requesting such a break. Likewise, an agent 12 upon seeing that breaks are immediately available may choose to request such a break at once rather than at a later time when breaks may not be as available.

As may be appreciated, it may be helpful to include as part of the break management system a supervisory reporting module that reports to a supervisor. Such supervisory reporting module may be associated with the central module 24 or may be located elsewhere, but in any event may function to provide instantaneous status of break activity of agents 12 to such a supervisor, and/or to provide historical summaries of break activity of agents 12 to such a supervisor. Instantaneous status may include the current status of any queues, any agents 12 that have been on break an inordinate amount of time, any ‘urgent’ agents 12 that are on emergency breaks, etc.

Historical summaries may include cumulative amounts of breaks over some window of activity for each agent 12, including numbers of breaks and elapsed time of breaks, which agents 12 have been taking breaks excessively, which agents 12 have been taking less breaks, etc. As should be appreciated, to compile such historical summaries, the central module 24 would be expected to account, compile, and store appropriate data on each break of each agent 12, and the supervisory reporting module or another module would be expected to analyze such data as appropriate. As should also be appreciated, from such historical summaries, the business center 10 can incentivize each agent 12 for minimizing breaks and/or penalize each agent 12 for excessive breaks, as was alluded to above.

In various embodiments of the present innovation, the break management system may be employed to approve and/or track types of time other than personal time that agents 12 may be expected to take away from servicing clients. For example, the break management system may be employed to approve and/or track so-called ‘down-time’ that an agent requires to attend a meeting, meet with a supervisor, visit with a manager, travel to a remote location, and/or the like. Moreover, in approving and/or tracking such other types of time and/or activities, the break management system of the present innovation may also track transition times for transitioning between activities at differing locations. For example, it may be that agents 12 at a business center 12 may spend at least a portion of their day working from an alternate work station 14. Such alternate work station 14 may be at any appropriate alternate location, such as an outdoor courtyard on a pleasant day, a conference room, perhaps for a special project, or even at an exercise machine fitted with appropriate functionality to allow the agent 12 to exercise while servicing a client, perhaps by way of a telephone connection therewith.

In any instance, it may be that the agent 12 employs the break management system, as appropriately modified to provide necessary functionality, to request the transition to the activity at the differing location, and that the break management system approves the requested transition if the activity at the differing location is available to the requesting agent. As should be appreciated, in such a case, the break management system may not only track whether the activity is available, such as for example that an exercise machine is not being used, but also that the agent 12 has the right to partake in the available activity, such as for example that the agent 12 is on an approved list of agents for the activity.

Additionally, the break management system, as appropriately modified to provide necessary functionality, may even track the time spent by an agent 12 in transitioning to and from the activity at the differing location, perhaps to count such transitioning time as personal time, or to count such transitioning time as personal time if such transitioning time is deemed excessive. If so, an agent 12 transitioning from his/her work station 14 to the differing location (a recumbent exercise bicycle, for example) may be considered to be taking a break for personal time during which the agent 12 is considered unavailable, and the break management system will for example consider the transitioning agent 12 as taking a break when determining whether a number of agents 12 currently on break for personal time has not reached a preset maximum amount as at 409. Of course, once the agent 12 has transitioned to the differing location, and presuming that the activity thereat involves being able to service clients, the agent 12 is then considered available so that another agent 12 might be granted a break.

### CONCLUSION

The programming believed necessary to effectuate the processes performed by the break management system including each agent module 22, the central module 24, and related components in connection with the various embodiments of the present innovation is relatively straight-forward and should be apparent to the relevant programming public. Accordingly, such programming is not attached hereto. Any particular programming, then, may be employed to effectuate the various embodiments of the present innovation without departing from the spirit and scope thereof.

In the present innovation, a system and method are set forth for managing the use of personal time by agents 12 or the like at a business center 10 or the like. Each agent 12 at the business center 10 is allowed to take a break for personal time if such break and personal time are not expected to unduly detract from the ability of the business center 10 to service the clients thereof. An agent 12 is ordinarily granted a break for personal time if predefined conditions within the business center 10 are satisfied, where the predefined conditions correspond to a set of rules for when breaks for personal time may be granted to agents 12. Accordingly, the agents 12 at the business center 10 can take breaks for personal time as needed while the business center 10 can service the clients thereof in a timely manner.

It should be appreciated that changes could be made to the embodiments described above without departing from the innovative concepts thereof. For example, although the present innovation is set forth primarily in terms of a business center 10 with a plurality of agents 12 thereat, such innovation may also be practiced with regard to other work settings and other types of business arrangements or in other settings, perhaps with suitable modification. For example, the work setting/business center 10 may be virtual in nature, with the agents 12 being communicatively coupled to a centralized entity to effectuate servicing of clients, perhaps with suitable modifications. Likewise, although the present innovation may be set forth with reference to breaks for personal time, the innovation may also be employed to manage breaks for other purposes as well as to manage other kinds of diversions from standard business processes, perhaps with suitable modification. Similarly, although the present innovation is set forth as employing virtual buttons or the like to receive a requested break and/or display break status information, such requests and such status information may alternately employ other types of interfacing devices, including controls, APIs, command-line interfaces, etc. It should be understood, therefore, that this innovation is not limited to the particular embodiments disclosed, but it is intended to cover modifications within the spirit and scope of the present innovation as defined by the appended claims.

1. A system for managing work breaks of agents in a work setting, each agent in the work setting working at a computing device, each agent being able to take work breaks as needed to devote personal time to attend to personal matters, the system comprising an agent module associated with the computing device of each agent and a central module central to all of the agents:
the agent module:
receiving a request from the agent for a work break; and
forwarding the request to the central module for processing thereat,
the central module:
receiving the request from the agent module;
examining the request according to a set of rules to determine whether and/or when the request for the work break from the agent is to be approved;
granting the request based on the set of rules; and
notifying the agent module that the request has been granted,
the agent module:
notifying the agent that the request has been granted, whereby the agent may take the requested work break.

2. The system of claim 1 wherein the agent module for each agent is instantiated on the computing device of the agent.

3. The system of claim 1 wherein the agent module receives the request from the agent for the work break when the agent selects a corresponding virtual button on a display of the computing device and in response thereto converts the virtual button to reflect that the request has been received, and wherein the agent module upon receiving from the central module the notification that the request has been granted converts the virtual button to reflect that the agent is on the work break.

4. The system of claim 1 wherein the agent module upon receiving from the central module the notification that the request has been granted shows on a display of the computing device a timer with an elapsed time of the work break.

5. The system of claim 1 wherein the central module upon receiving the request places same in a request queue with other requests from other agents, and handles each request serially as retrieved from the request queue.

6. The system of claim 1 wherein the central module in examining the request according to the set of rules determines that a number of agents currently on work breaks is less than a preset maximum amount.

7. The system of claim 1 wherein the central module in examining the request according to the set of rules determines that a current time is not a preset peak time for the work setting, the preset peak time being a time when the agents at the work setting are expected to experience peak activity.

8. The system of claim 1 wherein the central module tracks for each agent the prior work breaks thereof, and wherein the central module in examining the request according to the set of rules determines that the agent has not exceeded at least one of a preset number of work breaks and a preset cumulative temporal amount of work breaks.

9. The system of claim 1 wherein, upon the agent returning from the work break, the agent module receives a notification from the agent that the work break is ending and forwards the notification to the central module, and the central module closes out the work break.

10. The system of claim 1 wherein the central module periodically notifies the agents in the work setting of a status of the availability of work breaks in the work setting, the central module communicating to the agent modules of all of the agents the status, each agent module then communicating the status to the corresponding agent by way of a message or control on a display of the corresponding computing device.

11. A method with regard to a system for managing work breaks of agents in a work setting, each agent in the work setting working at a computing device, each agent being able to take work breaks as needed to devote personal time to attend to personal matters, the system comprising an agent module associated with the computing device of each agent and a central module central to all of the agents, the method comprising:
the agent module:
receiving a request from the agent for a work break; and
forwarding the request to the central module for processing thereat,
the central module:
receiving the request from the agent module;
examining the request according to a set of rules to determine whether and/or when the request for the work break from the agent is to be approved;
granting the request based on the set of rules; and
notifying the agent module that the request has been granted,
the agent module:
notifying the agent that the request has been granted, whereby the agent may take the requested work break.

12. The method of claim 11 wherein the agent module for each agent is instantiated on the computing device of the agent.

13. The method of claim 11 wherein the agent module receives the request from the agent for the work break when the agent selects a corresponding virtual button on a display of the computing device and in response thereto converts the virtual button to reflect that the request has been received, and wherein the agent module upon receiving from the central module the notification that the request has been granted converts the virtual button to reflect that the agent is on the work break.

14. The method of claim 11 wherein the agent module upon receiving from the central module the notification that the request has been granted shows on a display of the computing device a timer with an elapsed time of the work break.

15. The method of claim 11 wherein the central module upon receiving the request places same in a request queue with other requests from other agents, and handles each request serially as retrieved from the request queue.

16. The method of claim 11 wherein the central module in examining the request according to the set of rules determines that a number of agents currently on work breaks is less than a preset maximum amount.

17. The method of claim 11 wherein the central module in examining the request according to the set of rules determines that a current time is not a preset peak time for the work setting, the preset peak time being a time when the agents at the work setting are expected to experience peak activity.

18. The method of claim 11 wherein the central module tracks for each agent the prior work breaks thereof, and wherein the central module in examining the request according to the set of rules determines that the agent has not exceeded at least one of a preset number of work breaks and a preset cumulative temporal amount of work breaks.

19. The method of claim 11 wherein, upon the agent returning from the work break, the agent module receives a notification from the agent that the work break is ending and forwards the notification to the central module, and the central module closes out the work break.

20. The method of claim 11 wherein the central module periodically notifies the agents in the work setting of a status of the availability of work breaks in the work setting, the central module communicating to the agent modules of all of the agents the status, each agent module then communicating the status to the corresponding agent by way of a message or control on a display of the corresponding computing device.

21. The method of claim 11 further comprising:
the agent module:
receiving a transition request from the agent for a transition to an activity at a differing location; and
forwarding the transition request to the central module for processing thereat,
the central module:
receiving the transition request from the agent module;
examining the transition request according to a set of rules to determine whether and/or when the transition request to the activity at the differing location is to be approved;
granting the transition request based on the set of rules; and
notifying the agent module that the transition request has been granted,
the agent module:
notifying the agent that the transition request has been granted, whereby the agent may transition to the activity at the differing location.

22. The method of claim 21 wherein the central module in examining the request according to the set of rules determines that a sum of a number of agents currently on work breaks and a number of agents at differing locations is less than a preset maximum amount.

23. The method of claim 21 wherein the central module in examining the request according to the set of rules determines that the activity is available and that the agent has permission to partake in the available activity.

24. The method of claim 21 wherein the central module tracks an amount of time spent by the agent in transitioning to the activity at the differing location.
